(19) United States
(12) Patent Application Publication
(10) Pub. No.: US 2005/0238834 A1
(43) Pub. Date: Oct. 27, 2005

(54) High modulus label with compliant carrier sheet

(75) Inventors: Robert P. Bourdelais, Pittsford, NY (US); Cheryl J. Brickey, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/828,779

(22) Filed: Apr. 21, 2004

(51) Int. Cl. B32B 9/00

(52) U.S. Cl. 428/40.1

(57) ABSTRACT

The invention relates to a label stock comprising in order at least one pragmatic sheet, a pressure sensitive adhesive and a compliant carrier sheet.

### FIELD OF THE INVENTION

The invention relates to packaging materials. In a preferred form it relates to the use of thermal dye transfer label for the printing of text, graphics, and images applied to a package.

### BACKGROUND OF THE INVENTION

Pressure sensitive labels applied are applied to packages to build brand awareness, show the contents of the package, convey a quality message regarding the contents of a package, and supply consumer information such as directions on product use, or an ingredient listing of the contents. Printing on the pressure sensitive label is typically applied directly to the package or a printed media, typically printed using gravure printing or flexography is applied to the package. The three types of information applied to a pressure sensitive label are text, graphic, and images. Some packages only require one type of information, while other packages require more than one type of information. Utilizing traditional printing technology, the ability to apply variable data, that is data that changes for each label, is difficult because of the need to use printing plates or gravure cylinders.

Prior art labels that are applied to packages consist of a face stock material, a pressure sensitive adhesive, and a liner. The label substrate consisting of the face stock, pressure sensitive adhesive, and liner are typically laminated and then printed utilizing a variety of non-photographic printing methods. After printing, the labels are generally protected by an over laminate material or a protective coating. The completed label consisting of a protection layer, printed information, face stock, pressure sensitive adhesive, and liner material is applied to packages utilizing automated or hand labeling equipment.

Flexography is an offset letterpress technique where the printing plates are made from rubber or photopolymers. The printing on pressure sensitive label is accomplished by the transfer of ink from the raised surface of the printing plate to the surface of the material being printed. The rotogravure method of printing uses a print cylinder with thousands of tiny cells which are below the surface of the printing cylinder. The ink is transferred from the cells when the print cylinder is brought into contact with the pressure sensitive label at the impression roll. Printing inks for flexography or rotogravure include solvent based inks, water based inks, and radiation cured inks. While rotogravure and flexography printing does provide acceptable image quality, these two printing methods require expensive and time-consuming preparation of print cylinders or printing plates which make printing jobs of less than 100,000 units expensive as the setup cost and the cost of the cylinders or printing plates is typically depreciated over the size of the print job.

Recently, digital printing has become a viable method for the printing of information on packages. The term “digital printing” refers to the electronic digital characters or electronic digital images that can be printed by an electronic output device capable of translating digital information. The two main digital printing technologies applied to pressure sensitive labels are ink jet and electrophotography.

The introduction of piezo impulse drop-on-demand (DOD) and thermal DOD ink jet printers in the early 1980's provided ink jet printing systems. These early printers were very slow, and the ink jet nozzles often clogged. In the 1990's Hewlett Packard introduced the first monochrome ink jet printer, and, shortly thereafter the introduction of color, wide format ink jet printers enabled businesses to enter the graphic arts market. Today a number of different ink jet technologies are being used for packaging, desktop, industrial, commercial, photographic, and textile applications.

In piezo technology, a piezo crystal is electrically simulated to create pressure waves, which eject ink from the ink chamber. The ink can be electrically charged and deflected in a potential field, allowing the different characters to be created. More recent developments have introduced DOD multiple jets that utilize conductive piezo ceramic material which, when charged, increases the pressure in the channel and forces a drop of ink from the end of the nozzle. This allows for very small droplets of ink to form and be delivered at high speed at very high resolution, approximately 1,000 dpi printing.

Until recently, the use of color pigments in jet inks was uncommon. However, this is changing rapidly. Submicron pigments have been developed in Japan for ink jet applications. Use of pigments allows for more temperature resistant inks required for thermal ink jet printers and laminations. Pigmented water-based jet inks are commercially available, and UV-curable jet inks are in development. Pigmented inks have greater lightfastness and water-resistance.

Digital ink jet printing has the potential to revolutionize the printing industry by making short-run, color print jobs more economical. However, the next commercial stage will require significant improvements in ink jet technology; the major hurdle remaining is to improve print speed. Part of this problem is the limitation of the amount of data the printer can handle rapidly. The more complex the design, the slower the printing process. Right now they are about 10 times slower than comparable digital electrostatic printers. Further, in order to provide a producing printing system, undesirable solvent inks are often needed to increase evaporation of the inks.

Electrophotography was invented in the 1930's by Chester Carlson. By the early 1970's, the development of an electrophotographic color copier was being investigated by many companies. The technology for producing color copiers was already in place, but the market was not. It would take many more years until customer demand for color copies would create the necessary incentive to develop suitable electrostatic color copiers. By the late 1970's a few companies were using fax machines that could scan a document, reduce the images to electronic signals, send them out over the telephone wire and, using another fax machine, retrieve the electronic signals and print the original image using heat-sensitive papers to produce a printed copy.

In 1993 Indigo and Xeikon introduced commercial digital printing machines targeted on short-run markets that were dominated by sheet-fed lithographic printers. Elimination of intermediate steps associated with negatives and plates used in offset printing provides faster turnaround and better customer service. These digital presses share some of the characteristics of traditional xerography but use very specialized inks. Unlike inks for conventional photocopiers, these inks are made with very small particle size components in the range of 1 μm. Dry toners used in xerography are typically 8-10 μm in size.

In 1995 Indigo introduced the Ominus press designed for printing flexible packaging products. The Ominus uses a digital offset color process called One Shot Color that has six colors. A key improvement has been the use of special white Electro ink for transparent substrates. The Ominus web-fed digital printing system allows printing of various substrates using an offset cylinder that transfers the color image to the substrate. In principle, this allows perfect register regardless of the substrate being printed; paper, film, and metal can be printed by this process. This digital printing system is based on an electrophotographic process where the electrostatic image is created on the surface of a photoconductor by first charging the photoconductor by charge corona and exposing the photoconductive surface to a light source in image fashion.

The charged electrostatic latent image is then developed using ink containing an opposite charge to that on the image. This part of the process is similar to that of electrostatic toners associated with photocopying machines. The latent charged electrostatic image formed on the photoconductor surface is developed by means of electrophoretic transfer of the liquid toner. This electrostatic toner image is then transferred to a hot blanket, which coalesces the toner and maintains it in a tacky state until it is transferred to the substrate, which cools the ink and produces a tack-free print.

Electro inks typically comprise mineral oil and volatile organic compounds. They are designed so that the thermoplastic resin will fuse at elevated temperatures. In the actual printing process, the resin coalesces and the inks are transferred to the substrate. There is no need to heat the ink to dry it. The ink is deposited on the substrate essentially dry, although it becomes tack-free as it cools and reaches room temperature.

Photographic materials have been known for use as prints for preserving memories for special events such as birthdays and vacations. They also have been utilized for large display materials utilized in advertising. These materials have been known as high quality products that are costly and somewhat delicate, as they would be easily defaced by abrasion, water, or bending. Photographs are traditionally placed in frames, photo albums, and behind protective materials in view of their fragile and delicate nature, as well as their value. They are considered luxury items for the consumers to preserve a record of important events in their lives. They also have been considered as expensive display materials for advertising. In view of their status as luxury items, they have not been utilized in other areas of commerce. In U.S. Pat. No. 6,436,604 (Bourdelais et al.) a silver halide pressure sensitive label is proposed utilizing silver halide imaging layers applied to the surface of an oriented polyolefin base. While the label described in U.S. Pat. No. 6,436,604 is high in quality, provides high quality replication of flesh tones, and allows the printing of variable data, the wet chemistry used to develop the images makes a silver halide label impractical for converters and end users that do not have the equipment to handle the wet chemistry required for silver halide image processing.

Further, typical label facestock materials comprise oriented polyolefin or polyester sheets. The typical facestock materials also comprise a cavitated layer to provide thickness and stiffness to the label while saving materials. Polyolefin films are very useful as protective packaging because they resist tearing and water penetration. However, a significant drawback to their use is the difficulties encountered in writing, with ink, on the film. Typically, polyolefin films have low surface energies which make them nonreceptive to certain inks, particularly water based inks. The water based inks tend to exhibit bad ink wetting properties, in which they fail to form a complete coating on the film; the ink forms into discrete beads, streaks and splotches on the film. Additionally, water based inks tend to dry slowly, smear easily and rub off once dry. These are serious problems particularly when plastic films are used for shipping articles which are often exposed to moisture and rough handling. To overcome these difficulties written matter is usually applied to a paper label which is then attached to the wrapping but this is inconvenient and presents recycling problems because paper recycling is usually incompatible with plastic recycling.

Voided face stock materials have also been shown to increase the rate thermal dye transfer. Prior art thermal printing systems utilize both pressure and temperature to ensure efficient transfer of dye from a donor web to a receiver layer. U.S. Pat. No. 5,244,861 describes the increase in thermal dye transfer printing efficiency by the use of micro-cavitated polymer films located adjacent to the dye receiving layer, particularly polypropylene which are suitable for use as a pressure sensitive label. While the use of cavitated polymer films does improve the printing efficiency of thermal dye transfer printing several polymers such as polyurethane, polycarbonate and polyamides are difficult to cavitate and therefore can not be printed as efficiently as voided polymer films.

U.S. Pat. No. 5,071,825 (Iiyama et al.) describes a receiver sheet for dye diffusion thermal transfer printing utilizing a oriented polyester film containing a layer of high compliance. U.S. Pat. No. 4,935,402 (Imai et al.) describes a dye receiving sheet comprising a extruded stretched sheet that has a specific gravity from 1.0 to 1.38 to increase the rate of transfer of thermal dyes.

U.S. Pat. No. 4,984,823 (Ishii et al.) discloses a pressure sensitive label having a sublimation transferred image. While the image does have acceptable image quality, the label base comprises cellulose paper or oriented polymer. Both the paper and polymer label bases suffer from low stiffness for high speed label dispensing and the polymer labels are prone to shrinkage at high temperatures in demanding labeling conditions such as automobile engine labeling, labeling of food items that must endure high pasteurization and labeling of items that are exposed to outdoor conditions.

U.S. Pat. No. 6,153,588 (Shirai et al.) describes a thermal transfer receiving sheet for stickers utilizing non-cavitated release sheet. U.S. Pat. No. 5,302,574 (Lawerance et al.) and U.S. Pat. No. 5,387,571 (Daly et al.) describe thermal dye receiving layers that can achieve thermal printing dye densities of over 0.5 utilizing mixtures of polyester polymers. The melt extruded polyester dye receiving layer is preferably applied to a cellulose paper base.

### PROBLEM TO BE SOLVED BY THE INVENTION

There is a need for pressure sensitive labels for application to packages that are high in quality and, at the same time, economical for short runs. There is a further need for providing thermal pressure sensitive label without the use of a cavitated face stock.

### SUMMARY OF THE INVENTION

It is an object of the invention to provide higher quality images to packaging materials.

It is a further object to provide high quality label images that have bright and sharp images.

It is another object to provide efficient thermal dye transfer printing of non-cavitated face stock materials.

These and other objects of the invention are accomplished by a label stock comprising in order at least one pragmatic sheet, a pressure sensitive adhesive and a compliant carrier sheet.

### ADVANTAGEOUS EFFECT OF THE INVENTION

The invention provides improved image quality for packaging materials. The invention includes a printing method that can efficiently print high quality text figures, graphic and images from a digital file while providing a facestock that strong and able to be machine applied to packages.

### DETAILED DESCRIPTION OF THE INVENTION

The invention has numerous advantages over prior practices in the art. Recently there has been a trend in the marketing of mass consumer items to try to localize the marketing to separately approach smaller groups. These groups may be regional, ethnic, gender, age, or special interest differentiated. In order to approach these different groups, there is a need to provide packaging that is specifically directed to these groups. As discussed above, the traditional packaging materials are generally suited for very long runs of material, and to form shorter runs or to provide rapid changes in packaging is impossible or very expensive. We have found high quality digital printed images such as silver halide and thermal dye transfer materials that are suitable for packaging uses. Further, recently there has become available rapid thermal printing apparatus suitable for short runs of material. The combination of rapid thermal printing and facestock properties from the composite facestock such as flexibility, high strength, and the ability to flex and bend has resulted in materials satisfactory and suitable for packaging.

The invention utilizes a pliant carrier sheet, which allows efficient printing of thermal dye transfer labels. The pliant carrier sheet significantly reduces the need for a pliant face stock materials thereby allowing non-pliant cast face stock materials such as urethane, vinyl and polyolefin to be efficiently printed utilizing thermal dye transfer. Further, one pliant carrier sheet containing the required compression profile can be utilized with a number of face stock material reducing the complexity of providing numerous pliant face stock materials. Since the pliant carrier sheet is removed at the time of labeling, low cost pliant carrier sheet technology such as reactive foaming can be utilized without concern of FDA approval. Further, because the label is stripped from the compliant carrier sheet, expensive methods to reduce the surface roughness of the compliant carrier sheet are not required thereby reducing the complexity of the technology used in the manufacture of the compliant carrier sheet.

The utilization of the thin, flexible, and tough pragmatic material results in a packaging material having many superior properties. The invention materials are capable of having brighter, sharper, and higher color images than anything presently available in packaging. The packaging materials of the invention have a depth of image unsurpassed by existing packaging materials. The packaging materials of the invention may provide a variety of packing materials that are suitable for pressure sensitive labeling of packages such as shampoo bottles, perfume bottles, and film boxes. The packaging materials of the invention, as they may be imaged by digital printing from digital imaging files, have the ability to be formed in short runs, and to be rapidly switched from one image to the next without delay.

The imaged label materials of the invention allow packages to be rapidly designed and brought to market. For instance, significant events in sports or entertainment may be practically instantly brought to market as a digital image may be immediately flash exposed onto silver halide pressure sensitive labels and utilized within moments from the time of the event. This is in contrast to typical photogravure or flexographic imaging where lead times for pressure sensitive labels are typically several weeks. Further, the quality of the digitally formed image lends itself to collectable images formed as a part of packaging much better than previous images, which were of lower quality and were less desirable for collecting. Finally, the regional customization of images is rapidly possible.

The ability to rapidly change packaging also would find use in the need to provide regional labeling with different languages and marketing themes in different countries. Further, different countries have different legal labeling requirements as to content. For instance, alcoholic beverages such as wine and beer are subject to a wide variety of regional and national variations in labeling requirements. Wines manufactured in France may have long delays in shipping out of France due to the wait for national labeling in other countries. High quality digital images also would be particularly desirable for premium products such as fine wines, perfumes, and chocolates, as they would be of high quality and reflect the high quality of the product in the package.

The invention provides a printing method that is economically viable when printing short runs as the cost of printing plates or printing cylinders are avoided. The use of thermal dye transfer, silver halide or ink jet images applied to a package ensures the highest image quality currently available compared to the common, but lower quality six-color rotogravure printed images. Further, because the yellow, magenta, and cyan layers contained gelatin interlayers, the silver halide images appear to have depth compared to electrophotographic images, which appear flat and lifeless. The thermal dye transfer and silver halide layers have also been optimized to accurately replicate flesh tones, providing superior images of people compared to alternate prior art digital imaging technologies. These and other advantages will be apparent from the detailed description below.

The terms as used herein, “top”, “upper”, and “face” mean the side or toward the side of the packaging label bearing the imaging layers. The term environmental protection layer means the layer applied to the printed imaging layers. The terms “face stock”, “pragmatic sheet” and “substrate” mean the material to which the printing is applied. The terms “bottom”, “lower side”, “liner”, “carrier sheet” and “back” mean the side or toward the side of the label opposite from the side bearing the printed layers.

As used herein the term “recovery” is defined as the optical thickness of a material after the compressive load is removed. The recovery of a material after being subjected to a compressive load is related to the magnitude of the compressive load, the type of material, the elastic limit of the material, the humidity and temperature of the materials and the dynamics of the compressive load. The recovery percentage of a compressive layer is defined as 1 minus the ratio of the optical thickness after the compressive load has been removed to the optical thickness before the compressive load has been applied. The compressive load used to determine recovery percentage for thermal dye transfer printing is 1.2 MPa. For thermal dye transfer printing applications that typically require a compliant layer in the receiver material, the loading cycle is generally between 10 and 50 ms and at a temperature of between 150 and 200 degrees C. For other printing non-contact methods such as ink jet, flexographic or electophotographic printing, the printing temperatures are generally less than 50 degrees C.

“Peelable separation” or “peel strength” or “separation force” is a measure of the amount of force required to separate the silver halide label from the package to which the label has been applied. The peel strength is the amount of force required to separate two surfaces that are held together by internal forces of the photographic label adhesive, which consist of valence forces or interlocking action, or both. Peel strength is measured using an Instron gauge and peeling the sample at 180 degrees with a crosshead speed of 1.0 meters/min. The sample width is 5 cm and the distance peeled is 10 cm in length. The term as used herein “pliant” refers to the bulk compressible properties of a pragmatic sheet, pressure sensitive adhesive or carrier sheet. Pliant materials have at least a 10% deformation when a load of 1.2 MPa is applied to the surface of the pliant material and typically act as a spring, recovering when the load is less than the elastic limit the pliant material.

In order to provide printed labels that are high in quality and high in ink density, when utilizing printing technology that requires pressure, a label stock comprising in order at least one pragmatic sheet, a pressure sensitive adhesive and a compliant carrier sheet is preferred. The pliant layer of the invention provides an increase in ink receiver layer contact with thermal dye transfer printing heads which often comprise a ceramic bead containing resistors. It has been shown that by providing a pliant carrier sheet, the contact of the thermal resistive head can be roughly doubled compared to non-pliant label stocks yielding a significant increase in printing speed and dye transfer compared to non-pliant labels stocks. Surprisingly, it has been discovered that providing a pliant carrier sheet, printing efficiency and dye density utilizing thermal dye transfer is roughly equivalent to printing a pliant pragmatic sheet and a non-pliant carrier sheet. The pliant carrier sheet allows for the efficient printing of non-pliant pragmatic sheet such as cast polymer sheet, which are very difficult to cavitate.

The label stock of the invention preferably recovers 90% of the original thickness after a compression of between 25 and 50% of the original thickness. Recovery of 90% of the original thickness is preferred because thermal dye transfer typically utilizes a yellow, magenta and cyan dye to form Pantone colors utilized in the printing industry. The yellow, magenta and cyan dyes are transferred sequentially allowing for three compressions. If the label stock of the invention does not recover, the amount of dye transferred will change for each color as the bulk compressive nature of the material changes for each transferred dye. Significant changes to the bulk compressive properties of the pliant carrier sheet, indicated when the recovery is less than 85%, results in poor image quality and poor registration of the yellow, magenta and cyan dyes. Compressive load recovery is measured by applying a 1.2 MPa load to the surface of the pliant material for a duration of 60 seconds while the pliant material is at a temperature of 23 degrees C at 50% RH. The 1.2 MPa load is applied utilizing a circular probe having an area of 0.50 cm². The thickness of the pliant material is measured utilizing a laser micrometer and is measured immediately after removal of the 1.2 MPa load from the surface of the pliant material. The % recovery is the thickness of the pliant material after the load has been removed divided by the thickness of the pliant material before the load was applied at the measurement conditions of 23 degrees C and 50% RH.

The compliant carrier sheet of the invention preferably has a recovery time less than 2 seconds. It has been found that if the compliant carrier sheet of the invention recovers 95% of the original thickness for a load applied perpendicular to the surface of the label stock in less than 2 seconds, the quality of image is significantly improved compared to compliant carrier sheet with recovery time greater than 4 seconds. The recovery time of the compliant layer of the invention provides for improved printing efficiency for multiple color printing such as yellow, magenta and cyan printing of images, text or graphics. For thermal dye transfer printing, yellow, magenta and cyan records are typically printed in sequence. In some printers, the media is rewound into the printer providing a recovery period of about 10 seconds. Other thermal printers contain more than one print head. In this case recovery time of the compliant layer is typically 2 to 3 seconds. Timed compressive load recovery is measured by applying a 1.2 MPa load to the surface of the pliant material for a duration of 2 seconds while the pliant material is at a temperature of 23 degrees C at 50% RH. The 1.2 MPa load is applied utilizing a circular probe having an area of 0.50 cm². The thickness of the pliant material is measured utilizing a laser micrometer and is measured immediately after removal of the 1.2 MPa load from the surface of the pliant material. The % recovery is the thickness of the pliant material after the load has been removed divided by the thickness of the pliant material before the load was applied at the measurement conditions of 23 degrees C and 50% RH.

The compliant carrier sheet of the invention preferably comprises an air voided polymer layer. Polymer voided layers are preferred because they have been shown to provide consistent compression, excellent recovery and are low in cost. “Void” is used herein to mean devoid of added solid and liquid matter, although it is likely the “voids” contain gas. The void-initiating particles, which remain in the finished packaging sheet core, should be from 0.1 to 10 μm in diameter, preferably round in shape, to produce voids of the desired shape and size. The size of the void is also dependent on the degree of orientation in the machine and transverse directions. Ideally, the void would assume a shape that is defined by two opposed and edge contacting concave disks. In other words, the voids tend to have a lens-like or biconvex shape. The voids are oriented so that the two major dimensions are aligned with the machine and transverse directions of the sheet. The Z-direction axis is a minor dimension and is roughly the size of the cross diameter of the voiding particle. The voids generally tend to be closed cells, and thus there is virtually no path open from one side of the voided-core to the other side through which gas or liquid can traverse.

The void-initiating material may be selected from a variety of materials, and should be present in an amount of about 5 to 50% by weight based on the weight of the core matrix polymer. Preferably, the void-initiating material comprises a polymeric material. When a polymeric material is used, it may be a polymer that can be melt-mixed with the polymer from which the core matrix is made and be able to form dispersed spherical particles as the suspension is cooled down. Examples of this would include nylon dispersed in polypropylene, polybutylene terephthalate in polypropylene, or polypropylene dispersed in polyethylene terephthalate. If the polymer is preshaped and blended into the matrix polymer, the important characteristic is the size and shape of the particles. Spheres are preferred and they can be hollow or solid. These spheres may be made from cross-linked polymers which are members selected from the group consisting of an alkenyl aromatic compound having the general formula Ar—C(R)═CH₂, wherein Ar represents an aromatic hydrocarbon radical, or an aromatic halohydrocarbon radical of the benzene series and R is hydrogen or the methyl radical; acrylate-type monomers include monomers of the formula CH₂═C(R′)—C(O)(OR) wherein R is selected from the group consisting of hydrogen and an alkyl radical containing from about 1 to 12 carbon atoms and R′ is selected from the group consisting of hydrogen and methyl; copolymers of vinyl chloride and vinylidene chloride, acrylonitrile and vinyl chloride, vinyl bromide, vinyl esters having formula CH₂═CH(O)COR, wherein R is an alkyl radical containing from 2 to 18 carbon atoms; acrylic acid, methacrylic acid, itaconic acid, citraconic acid, maleic acid, fumaric acid, oleic acid, vinylbenzoic acid; the synthetic polyester resins which are prepared by reacting terephthalic acid and dialkyl terephthalics or ester-forming derivatives thereof, with a glycol of the series HO(CH₂)ₙOH wherein n is a whole number within the range of 2-10 and having reactive olefinic linkages within the polymer molecule, the above described polyesters which include copolymerized therein up to 20 percent by weight of a second acid or ester thereof having reactive olefinic unsaturation and mixtures thereof, and a cross-linking agent selected from the group consisting of divinylbenzene, diethylene glycol dimethacrylate, diallyl fumarate, diallyl phthalate and mixtures thereof.

Examples of typical monomers for making the void initiating crosslinked polymer include styrene, butyl acrylate, acrylamide, acrylonitrile, methyl methacrylate, ethylene glycol dimethacrylate, vinyl pyridine, vinyl acetate, methyl acrylate, vinylbenzyl chloride, vinylidene chloride, acrylic acid, divinylbenzene, acrylamidomethyl-propane sulfonic acid, vinyl toluene, etc. Preferably, the cross-linked polymer is polystyrene or poly(methyl methacrylate). Most preferably, it is polystyrene and the cross-linking agent is divinylbenzene.

Processes well known in the art yield non-uniformly sized particles, characterized by broad particle size distributions. The resulting beads can be classified by screening the beads spanning the range of the original distribution of sizes. Other processes such as suspension polymerization, limited coalescence, directly yield very uniformly sized particles.

The void-initiating materials may be coated with agents to facilitate voiding. Suitable agents or lubricants include colloidal silica, colloidal alumina, and metal oxides such as tin oxide and aluminum oxide. The preferred agents are colloidal silica and alumina, most preferably, silica. The cross-linked polymer having a coating of an agent may be prepared by procedures well known in the art. For example, a conventional suspension polymerization process wherein the agent is added to the suspension is preferred. As the agent, colloidal silica is preferred.

The void-initiating particles can also be inorganic spheres, including solid or hollow glass spheres, metal or ceramic beads or inorganic particles such as clay, talc, barium sulfate, and calcium carbonate. The important thing is that the material does not chemically react with the core matrix polymer to cause one or more of the following problems: (a) alteration of the crystallization kinetics of the matrix polymer, making it difficult to orient, (b) destruction of the core matrix polymer, (c) destruction of the void-initiating particles, (d) adhesion of the void-initiating particles to the matrix polymer, or (e) generation of undesirable reaction products, such as toxic or high color moieties.

In addition to polymer bead voided polymer sheets, the cushioning layer may be formed by the incorporation of solid particles or non-compatible polymer within the base resin and then oriented in at least one direction. The incorporation of non-compatible polymers or solid inorganic particles has been shown to provide voiding in the compliant layer. Cushioned layer may also be formed be chemical or physical blowing agents. Typical material comprises one or more from the list of azodicarbonamide, zeolite or molecular sieves, gases such as nitrogen, carbon dioxide or liquids that turn to gas at atmospheric pressure. Microcellular polymer may be created by saturation of the polymer with a gas such as nitrogen, carbon dioxide or other gas to achieve a bubble density in the range of 0.05 to 5 billion/cm³. It is desirable to balance the density of foam to solid phase polymer. Excessive bubble density will alter the mechanical properties of the polymer sheet. Such properties as tensile yield, modulus, compressibility, mechanical stress cracking and others are impacted. Annealing the sheet provides some beneficial impact to the mechanical properties. Advantages to a microcellular foamed sheet or layer in the case when it is coextruded with other solid or filled layers enhances opacity, sharpness, cushioning and overall whiteness of the structure. The mircocellular foam layer may be coextruded with other solid layers that are either clear or filled with pigment, tinting and optical brightening materials to achieve end photographic property. A preferred embodiment would comprise an upper surface of a solid polymer such as a polyolefin. This layer may further comprise tinting pigments or dyes to offset any color imparted to the final photographic print. Directly under this layer is another polymer layer that is most preferably a polyolefin or polyester comprising a white pigment. Suitable white pigments may be TiO₂, BaSO₄, clay, ZnS, talc and others known in the art. Said pigment loading may be between 4-60% by weight of that layer. Thickness of said layer may also be varied to achieve the desired optical properties. Directly under this layer is a layer of microcellular foamed polymer. Such a layer may comprises any suitable polymer such as polyolefin and their copolymers, polyester, polystyrene and others that has been super-saturated with a gas such that as it is heated to the optimal temperature that microcellular foam is generated within that polymer layer. Said structure would further comprise a solid layer of polymer on the backside or side next to the support substrate. This structure may be coextruded directly on the support substrate or may be formed, oriented and annealed as a separate polymer sheet that is then laminated to a support utilizing an adhesive. Such a structure is able to develop good mechanical properties, excellent optical properties as well as having excellent cushioning and compressibility properties to prevent pressure sensitivity issues such as yellow edge with photographic emulsions. Such a structure would also provide excellent cushioning for the thermal dye transfer process for generating near photographic image quality. The compressibility of the microcellular layer allows the dye donor ribbon and the image receiving layer to develop intimate contact as well as to provide a degree of thermal insulation to assure complete transfer of dye to the desired area of the receiver. Such a compressible layer will allow the use of slightly rougher supports without loss of dye transfer. Furthermore it enhances the speed at which the dyes may be transferred to the receiver.

Another preferred means to achieve a compliant carrier sheet is to use a chemical blowing agent. A blowing agent is any material, which yields an insoluble gas in a polymer matrix under conditions for extrusion. Two of the preferred blowing agents are azodicarbonamide and sodium bicarbonate. Azodicarbonamide exothermially forms nitrogen and carbon dioxide. The microcellular foam structure is produced by the decomposition of the chemical blowing agent. The gas dissolves in the molten polymer because of the high pressure in the extruder. It is important to optimize the foam nucleation at the point of exiting the die. The drop in pressure causes the gas to become super-saturated. Once the polymer is chilled rapidly the foam bubbles freeze into the polymer as its viscosity increases. This technique is sensitive to processing conditions within the extruder as well as the reheological properties of the polymer. The most preferable means is to combine the chemical blowing agent within a polymer in combination with coextrusion of other layers to provide enhanced adhesion of the photographic or imaging layer to the top most polymer layer. Furthermore layers of polymer may also be coextruded that comprise pigment, tinting or optical brightening materials. The addition of these materials is critical to providing an element that has optimal whiteness, sharpness and opacity. It may also be necessary to add processing aid to enhance the foaming process as well as the compatibility of the other polymer layers during extrusion. Materials such as antioxidants, slip agents, filler, ultraviolet screening and other may be necessary.

In a preferred embodiment of the invention, the compliant carrier sheet comprises polyester polymer having at least one voided layer. Polyester polymer is preferred because it provides excellent mechanical properties such as mechanical modulus, temperature resistance and scratch resistance compared to polyolefin polymer sheets. Further, it has been shown that label die cutting is improved because of the mechanical toughness of the polyester carrier sheet compared to either paper carrier sheets or polyolefin carrier sheets.

In another preferred embodiment of the invention, the voided layer of the carrier sheet of the invention is located adjacent to the pressure sensitive adhesive. It has been found that by locating the voided layer adjacent to the adhesive layer, the compressive properties of the compliant layer are optimized. Because of the transfer of compressive forces through the composite layers of the label stock, the printing contribution of the compliant layer is inversely proportional to the distance away from the pressure sensitive adhesive layer.

In another preferred embodiment of the invention, the compliant carrier sheet comprises a release layer between the adhesive layer and the voided layer. By providing a release layer between the voided layer and the adhesive layer the pragmatic sheet of the invention can easily be removed from the compliant carrier sheet thus allow the pragmatic sheet to be applied to packages utilizing automated packaging equipment. The release layer preferably has a peel force of between 20 and 45 grams/cm width over a length of 10 cm. This range has been shown to provide easy release of the pragmatic sheet while providing sufficient adhesion to allow the label stock to be printed.

The compliant carrier sheet of the invention preferably has a compliant factor of between 20 and 100 micrometers. A compliant factor is the measure of the deflection of the voided layer under a load of 1.2 MPa, for 10 ms at a probe temperature of 100 degrees C. The 1.2 MPa load is applied utilizing a circular ceramic probe having an area of 0.50 cm². The thickness of the pliant layer is measured utilizing a laser micrometer. A compliant factor less than 15 micrometers does not provide sufficient deflection of the thermal printing head and results in low printing efficiency. A compliant factor greater than 120 micrometers exceeds the large surface area contact between the thermal resistive head and the thermal receiving layer causing dye donor sticking and low printing density.

The compliant carrier sheet of the invention preferably has a modulus of at least 2500 MPa. Compliant carrier sheet of the invention having a modulus less than 2,000 MPa have been shown to elongate during printing to the label stock material increasing the amount of mis-registration of the printed inks or dyes. Mis-registration of ink and dyes causes images to become out of focus and results in bar codes that are not machine readable.

In a preferred embodiment of the invention, the pragmatic sheet has a bulk modulus of between 2000 and 100,000 MPa. This range of modulus has been shown to provide efficient labeling on labeling equipment. Further, this range of modulus has also been shown to provide tough labels that can withstand the rigors of consumer labels.

The compliant carrier sheet of the invention preferably is reflective to collimated light. The use of collimated light that emits from laser light sources is well know to be used for cutting the un-printed regions of labels prior to stripping the un-printed regions of the label. A reflective compliant carrier sheet of the invention more efficiently spectrally reflects the high energy collimated light energy maintaining a high degree of columniation to the cutting areas resulting in a cleaner, quicker cut compared to translucent carrier sheets. Further, the use of collimated light energy to cut the pragmatic sheet allows the density of the compliant carrier sheet to lower compared to die cutting of the pragmatic sheet. It has been shown that compliant carrier sheets are difficult to die cut cleanly as some of the die cutting energy is dissipated when the compliant layer is compressed.

The compliant carrier sheet of the invention preferably has a surface resistivity of less than 10¹² ohms per square. Because the compliant carrier sheet contains air, the charge capacity of the compliant sheet is often higher than a solid sheet of polymer. High surface charge is undesirable because of static discharge during application of ink or dye receiving layers and because static significantly increases picking force from a stack of labels. By providing a surface resisitivity of less than 10¹², the tendency for the invention materials to suffer from the above static problems is reduced.

The antistatic material is preferably incorporated into the pressure the compliant carrier sheet or the pragmatic sheet, most preferably into the adhesive layer. Incorporation of antistatic materials into the adhesive layer allows for a broader range of materials to be utilized because the adhesive layer is contained between the pragmatic sheet and the compliant carrier sheet of the invention. Further, the use of antistatic materials in the adhesive have been shown to improve labeling efficiency during application of labels to packages by reducing static charge during the labeling, especially at label speeds in excess of 100 pieces/min. The materials preferably comprise an antistatic agent selected from the group consisting of conductive metal oxides, carbon particles, and synthetic smectite clay, or multilayered with an inherently conductive polymer. In one of the preferred embodiments, the antistat material is metal oxides. Metal oxides are preferred because they are readily dispersed in the thermoplastic adhesive and can be applied to the polymer sheet by any means known in the art. Conductive metal oxides that may be useful in this invention are selected from the group consisting of conductive particles including doped-metal oxides, metal oxides containing oxygen deficiencies, metal antimonates, conductive nitrides, carbides, or borides, for example, TiO₂, SnO₂, Al.₂O₃, ZrO₃, In₂O₃, MgO, ZnSb₂O₆, InSbO₄, TiB₂, ZrB₂, NbB₂, TaB₂, CrB₂, MoB, WB, LaB₆, ZrN, TiN, TiC, and WC. The most preferred materials are tin oxide and vanadium pentoxide because they provide excellent conductivity and are transparent.

The label stock of the invention preferably has an adhesive thickness of between 12 and 25 micrometers. This range of adhesive thickness has been shown to provide excellent adhesion to packaging surface of interest including glass, plastic, carton stock and metallic surfaces. Adhesive thickness less than 10 micrometers does not provide sufficient adhesion to packaging surfaces. Adhesive thickness greater than 30 micrometers begins to fail when exposed to shear forces encountered during consumer product lifecycles.

In a preferred embodiment of the invention, the pragmatic sheet comprises cellulose paper. Paper is lower in cost as compared to polymer pragmatic sheet, paper provides a unique texture that has wide consumer appeal and paper and paper contains salt and moisture, which have been shown to provide low electrical resistivity.

In another preferred embodiment of the invention, the pragmatic sheet preferably comprises a substantially transparent sheet. A polymer sheet with a light transmission greater than 80% or more preferably a sheet with a light transmission greater than 90% provides a label that tend to blend into the package, otherwise known as the “no label look”. Further, dye based imaging systems such as ink jet or thermal dye transfer offer semi-transparent dye sets which allow the printed portion of the label to interact with the package, the contents of the package or a back label that is aligned with the transparent pragmatic sheet label. In particular, it has been found the printing efficiency of thermal dye transfer labels is dependant on a compressible layer located at or near the printing surface. Since voided pragmatic sheet are opaque by nature, transparent pragmatic sheets are difficult to print utilizing thermal dye transfer printing technology. Surprisingly, it has been found that printing efficiency of thermal dye transfer labels can be maintained compared to voided pragmatic sheets by the use of a compliant carrier sheet.

In another preferred embodiment of the invention, the pragmatic sheet of the invention comprises a layer of gelatin adjacent to the pressure sensitive layer. The gelatin layer allows for ink printing of the back of the pragmatic sheet allowing the pragmatic sheet to have printing on both sides, a configuration that has value for the labeling of translucent packages such as clear PET beverage bottles. The gelatin layer also functions an adhesion layer for the pressure sensitive adhesive allowing for more efficient coating of the pressure sensitive adhesive. The gelatin layer also functions as a curl control layer in printing and labeling environments with a relative humidity less than 30% RH. Because the gelatin layer contracts when the humidity is less than 30%, a desirable curl toward the adhesive is imparted to the pragmatic sheet at the time of labeling and while the label is adhered to the package especially as the label package is displayed and sold in low humidity markets.

In another preferred embodiment of the invention, the pragmatic sheet is preferably provided with a thermal dye receiving layer adjacent to the adhesive layer. By providing a thermal dye transfer layer adjacent to the adhesive layer, the pragmatic sheet can be printed both sides. The pragmatic sheet is preferably coated both sides with the thermal dye receiving layer, printed on the adhesive side and finally pressure sensitive laminated to the compliant carrier sheet of the invention. Likewise, preferably, the pragmatic sheet is provided with an ink jet receiving layer adjacent to the adhesive layer. The ink jet receiving layer provides a layer for printing of text, images or graphics prior to pressure sensitive adhesive lamination to the compliant carrier sheet of the invention.

A preferred method for the formation of the labels of the invention comprises in order a pragmatic sheet, a pressure sensitive adhesive and a compliant carrier sheet, thermal dye transfer printing a label image on said pragmatic sheet, cutting said label image, and removing matrix material from said label images. Thermal dye transfer labels have been shown to provide excellent text, graphics and image quality compared to ink printing utilizing flexography. Further, thermal dye transfer printing has been shown to be accomplished in a small space and utilizes materials that do not create unwanted volatile emissions.

Because the compliant carrier sheet of the invention is highly compressible compared to a paper or PET liner, the cutting of the label is preferably accomplished by cutting means that generates low cutting forces. The label of the invention is preferable cut by means of a laser. The laser has no contact force and has been shown to provide excellent cut quality.

Laser scoring is accomplished by focusing a high power laser beam on to the surface of the pragmatic sheet to be scored. In this case, the web materials of the invention is preferably translated under a stationary focused laser beam. The depth of the laser score into the pragmatic sheet of the invention is critical to the performance of the scoring operation. Insufficient depth of laser score results in incomplete slitting and thus separation of the pragmatic sheet from the carrier sheet. A laser score than penetrates too far into the carrier sheet results in a loss of bending resistance as the carrier sheet is partially fractured. Depth of laser score is a function of the laser power density per unit area and the translation velocity of the focused spot in relation to the material. The translation of the material or translation of the focused spot can be described as laser energy density per unit area. Laser scoring can be accomplished with either a repetitively pulsed laser or a continuous wave (CW) laser. The pulse rate of the laser should be approximately 1 pulse per second to continuous. The laser optical power should be sufficient to ablate or vaporize the material to be scored when focused with a positive lens. The focal length of the lens preferably is in the range of 3 mm to 500 mm. The wavelength of the laser should be of a wavelength that is absorptive to the pragmatic sheet being scored. The preferred wave length for the scoring of the pragmatic sheet of the invention is between 100 nm to 20,000 nm wavelength.

In another preferred embodiment, the cutting of the label is accomplished by a X-Y cutter. An X-Y cutter is a reciprocating knife blade that has been shown to provide very low compression of the compliant carrier sheet and thus provides excellent cut quality.

Cutting into the pragmatic sheet of the invention causes label dispensing problems as the pressure sensitive adhesive utilized in the invention is driven into the cut in the carrier sheet significantly increasing peel force of the pragmatic sheet to the compliant carrier sheet. Preferably, the cut depth is less than 5 micrometers into the compliant carrier sheet. It has been found that a cut depth of 5 micrometers does allow for label stripping in high speed label dispensing equipment. More preferably, the compliant carrier sheet is not cut by the cutting process thus allowing for the efficient dispensing of the label.

Suitable label adhesives of this invention must not interact with the imaging systems so that image quality is deteriorated. Suitable adhesives may be inorganic or organic, natural or synthetic, that is capable of bonding the image to the desired surface by surface attachment. Examples of inorganic adhesives are soluble silicates, ceramic and thermosetting powdered glass. Organic adhesives may be natural or synthetic. Examples of natural organic photographic label adhesives include bone glue, soybean starch cellulosics, rubber latex, gums, terpene, mucilages and hydrocarbon resins. Examples of synthetic organic adhesives include elastomer solvents, polysulfide sealants, theromplastic resins such as isobutylene and polyvinyl acetate, theromsetting resins such as epoxy, phenoformaldehyde, polyvinyl butyral and cyanoacrylates and silicone polymers. Acrylic based adhesives are preferred because acrylic generally does not interfer with the quality of the imaging systems, is low in cost and has the desired performance properties.

The thermal dye image-receiving layer of the preferred receiving elements of the invention may comprise polymers or mixtures of polymers that provide sufficient dye density, printing efficiency and high quality images. For example, polycarbonate, polyurethane, polyester, polyvinyl chloride, poly(styrene-co-acrylonitrile), poly(caprolactone), polylatic acid, saturated polyester resins, polyacrylate resins, poly(vinyl chloride-co-vinylidene chloride), chlorinated polypropylene, poly(vinyl chloride-co-vinyl acetate), poly(vinyl chloride-co-vinyl acetate-co-maleic anhydride), ethyl cellulose, nitrocellulose, poly(acrylic acid) esters, linseed oil-modified alkyd resins, rosin-modified alkyd resins, phenol-modified alkyd resins, phenolic resins, maleic acid resins, vinyl polymers, such as polystyrene and polyvinyltoluene or copolymer of vinyl polymers with methacrylates or acrylates, poly(tetrafluoroethylene-hexafluoropropylene), low-molecular weight polyethylene, phenol-modified pentaerythritol esters, poly(styrene-co-indene-co-acrylonitrile), poly(styrene-co-indene), poly(styrene-co-acrylonitrile), poly(styrene-co-butadiene), poly(stearyl methacrylate) blended with poly(methyl methacrylate). Among them, a mixture of a polyester resin and a vinyl chloridevinyl acetate copolymer is preferred, with the mixing ratio of the polyester resin and the vinyl chloride-vinyl acetate copolymer being preferably 50 to 200 parts by weight per 100 parts by weight of the polyester resin. By use of a mixture of a polyester resin and a vinyl chloride-vinyl acetate copolymer, light resistance of the image formed by transfer on the image-receiving layer can be improved.

The thermal dye image-receiving layer may be present in any amount that is effective for the intended purpose. In general, good results have been obtained at a concentration of from about 1 to about 10 g/m². An overcoat layer may be further coated over the dye-receiving layer, such as described in U.S. Pat. No. 4,775,657 of Harrison et al.

In another embodiment of the invention, the thermal dye receiving layer comprises a polyester. Polyesters are low in cost and have good strength and surface properties. Polyesters have high optical transmission values that allow for high light transmission and diffusion. This high light transmission and diffusion allows for greater differences in the bright and dark projected areas increasing contrast. In a preferred embodiment of the invention, the polyesters have a number molecular weight of from about 5,000 to about 250,000 more preferably from 10,000 to 100,000.

The polymers used in the dye-receiving elements of the invention are condensation type polyesters based upon recurring units derived from alicyclic dibasic acids and diols wherein one or more alicyclic ring containing dicarboxylic acid units with each carboxyl group within two carbon atoms of (preferably immediately adjacent) the alicyclic ring are present and one or more diol units each containing at least one aromatic ring not immediately adjacent to (preferably from 1 to about 4 carbon atoms away from) each hydroxyl group or an alicyclic ring which may be adjacent to the hydroxyl groups. For the purposes of this invention, the terms “dibasic acid derived units” and “dicarboxylic acid derived units” are intended to define units derived not only from carboxylic acids themselves, but also from equivalents thereof such as acid chlorides, acid anhydrides and esters, as in each case the same recurring units are obtained in the resulting polymer. Each alicyclic ring of the corresponding dibasic acids may also be optionally substituted, e.g. with one or more C1 to C4 alkyl groups. Each of the diols may also optionally be substituted on the aromatic or alicyclic ring, e.g. by C1 to C6 alkyl, alkoxy, or halogen.

In another embodiment of the invention, the polymer layer comprises a polycarbonate. The diffusion elements formed out of polycarbonate are easily melted to form areas of specular and diffuse transmission. Polycarbonates have high optical transmission values that allow for high light transmission and diffusion. This high light transmission and diffusion allows for greater differences in the bright and dark projected areas increasing contrast.

Polycarbonates (the term “polycarbonate” as used herein means a carbonic acid and a diol or diphenol) and polyesters have been suggested for use in image-receiving layers. Polycarbonates (such as those disclosed in U.S. Pat. Nos. 4,740,497 and 4,927,803) have been found to possess good dye uptake properties and desirable low fade properties when used for thermal dye transfer. As set forth in U.S. Pat. No. 4,695,286, bisphenol-A polycarbonates of number average molecular weights of at least about 25,000 have been found to be especially desirable in that they also minimize surface deformation that may occur during thermal printing.

Polyesters, on the other hand, can be readily synthesized and processed by melt condensation using no solvents and relatively innocuous chemical starting materials. Polyesters formed from aromatic diesters (such as disclosed in U.S. Pat. No. 4,897,377) generally have good dye up-take properties when used for thermal dye transfer. Polyesters formed from alicyclic diesters disclosed in U.S. Pat. No. 5,387,571 (Daly et al.) and polyester and polycarbonate blends disclosed in U.S. Pat. No. 5,302,574 (Lawrence et al.), the disclosure of which is incorporated by reference.

Polymers may be blended for use in the dye-receiving layer in order to obtain the advantages of the individual polymers and optimize the combined effects. For example, relatively inexpensive unmodified bisphenol-A polycarbonates of the type described in U.S. Pat. No. 4,695,286 may be blended with the modified polycarbonates of the type described in U.S. Pat. No. 4,927,803 in order to obtain a receiving layer of intermediate cost having both improved resistance to surface deformation which may occur during thermal printing and to light fading which may occur after printing. A problem with such polymer blends, however, results if the polymers are not completely miscible with each other, as such blends may exhibit a certain amount of haze. While haze is generally undesirable, it is especially detrimental for transparent labels. Blends that are not completely compatible may also result in variable dye uptake, poorer image stability, and variable sticking to dye donors.

In a preferred embodiment of the invention, the alicyclic rings of the dicarboxylic acid derived units and diol derived units contain from 4 to 10 ring carbon atoms. In a particularly preferred embodiment, the alicyclic rings contain 6 ring carbon atoms.

A dye-receiving element for thermal dye transfer comprising a miscible blend of an unmodified bisphenol-A polycarbonate having a number molecular weight of at least about 25,000 and a polyester comprising recurring dibasic acid derived units and diol derived units, at least 50 mole % of the dibasic acid derived units comprising dicarboxylic acid derived units containing an alicyclic ring within two carbon atoms of each carboxyl group of the corresponding dicarboxylic acid, and at least 30 mole % of the diol derived units containing an aromatic ring not immediately adjacent to each hydroxyl group of the corresponding diol or an alicyclic ring are preferred. This polymer blend has excellent dye uptake and image dye stability, and which is essentially free from haze. It provides a receiver having improved fingerprint resistance and retransfer resistance, and can be effectively printed in a thermal printer with significantly reduced thermal head pressures and printing line times. Surprisingly, these alicyclic polyesters were found to be compatible with high molecular weight polycarbonates.

Examples of unmodified bisphenol-A polycarbonates having a number molecular weight of at least about 25,000 include those disclosed in U.S. Pat. No. 4,695,286. Specific examples include Makrolon 5700 (Bayer AG) and LEXAN 141 (General Electric Co.) polycarbonates.

In a further preferred embodiment of the invention, the unmodified bisphenol-A polycarbonate and the polyester polymers are blended at a weight ratio to produce the desired Tg of the final blend and to minimize cost. Conveniently, the polycarbonate and polyester polymers may be blended at a weight ratio of from about 75:25 to 25:75, more preferably from about 60:40 to about 40:60.

Among the necessary features of the polyesters for the blends of the invention is that they do not contain an aromatic diester such as terephthalate, and that they be compatible with the polycarbonate at the composition mixtures of interest. The polyester preferably has a Tg of from about 40C to about 100C, and the polycarbonate a Tg of from about 100C to about 200C. The polyester preferably has a lower Tg than the polycarbonate, and acts as a polymeric plasticizer for the polycarbonate. The Tg of the final polyester/polycarbonate blend is preferably between 40C and 100C. Higher Tg polyester and polycarbonate polymers may be useful with added plasticizer. Preferably, lubricants and/or surfactants are added to the dye receiving layer for easier processing and printing. The lubricants can help in polymer extrusion, casting roll release, and printability. Preferably, the polyester dye receiving layer is melt extruded on the outer most surface of the upper polymer sheet.

Dye-donor elements that are used with the dye-receiving element of the invention conventionally comprise a support having thereon a dye containing layer. Any dye can be used in the dye-donor employed in the invention, provided it is transferable to the dye-receiving layer by the action of heat. Especially good results have been obtained with sublimable dyes. Dye donors applicable for use in the present invention are described, e.g., in U.S. Pat. Nos. 4,916,112; 4,927,803; and 5,023,228. As noted above, dye-donor elements are used to form a dye transfer image. Such a process comprises image-wise-heating a dye-donor element and transferring a dye image to a dye-receiving element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads, which can be used to transfer dye from dye-donor elements to receiving elements of the invention, are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage of the invention comprises (a) a dye-donor element, and (b) a dye-receiving element as described above, the dye-receiving element being in a superposed relationship with the dye-donor element so that the dye layer of the donor element is in contact with the dye image-receiving layer of the receiving element.

When a three-color image is to be obtained, the above assemblage is formed on three occasions during the time when heat is applied by the thermal printing head. After the first dye is transferred, the elements are peeled apart. A second dye-donor element (or another area of the donor element with a different dye area) is then brought in register with the dye-receiving element and the process repeated. The third color is obtained in the same manner. When used as ink jet imaging media, the recording elements or media typically comprise a substrate or a support material having on at least one surface thereof an ink-receiving or image-forming layer. If desired, in order to improve the adhesion of the ink receiving layer to the support, the surface of the support may be corona-discharge-treated prior to applying the solvent-absorbing layer to the support or, alternatively, an undercoating, such as a layer formed from a halogenated phenol or a partially hydrolyzed vinyl chloride-vinyl acetate copolymer, can be applied to the surface of the support. The ink receiving layer is preferably coated onto the support layer from water or water-alcohol solutions at a dry thickness ranging from 3 to 75 micrometers, preferably 8 to 50 micrometers.

Known ink jet receiver layers can be used in combination with the compliant carrier sheet of the present invention. For example, the ink receiving layer may consist primarily of inorganic oxide particles such as silicas, modified silicas, clays, aluminas, fusible beads such as beads comprised of thermoplastic or thermosetting polymers, non-fusible organic beads, or hydrophilic polymers such as naturally-occurring hydrophilic colloids and gums such as gelatin, albumin, guar, xantham, acacia, chitosan, starches and their derivatives, and the like; derivatives of natural polymers such as functionalized proteins, functionalized gums and starches, and cellulose ethers and their derivatives; and synthetic polymers such as polyvinyloxazoline, polyvinylmethyloxazoline, polyoxides, polyethers, poly(ethylene imine), poly(acrylic acid), poly(methacrylic acid), n-vinyl amides including polyacrylamide and polyvinylpyrrolidone, and poly(vinyl alcohol), its derivatives and copolymers; and combinations of these materials. Hydrophilic polymers, inorganic oxide particles, and organic beads may be present in one or more layers on the substrate and in various combinations within a layer.

A porous structure may be introduced into ink receiving layers comprised of hydrophilic polymers by the addition of ceramic or hard polymeric particulates, by foaming or blowing during coating, or by inducing phase separation in the layer through introduction of non-solvent. In general, it is preferred for the base layer to be hydrophilic, but not porous. This is especially true for photographic quality prints, in which porosity may cause a loss in gloss. In particular, the ink receiving layer may consist of any hydrophilic polymer or combination of polymers with or without additives as is well known in the art.

If desired, the ink receiving layer can be overcoated with an ink-permeable, anti-tack protective layer, such as, for example, a layer comprising a cellulose derivative or a cationically-modified cellulose derivative or mixtures thereof. An especially preferred overcoat is poly β-1,4-anhydro-glucose-g-oxyethylene-g-(2′-hydroxypropyl)-N,N-d imethyl-N-dodecylammonium chloride. The overcoat layer is non porous, but is ink permeable and serves to improve the optical density of the images printed on the element with water-based inks. The overcoat layer can also protect the ink receiving layer from abrasion, smudging, and water damage. In general, this overcoat layer may be present at a dry thickness of about 0.1 to about 5 μm, preferably about 0.25 to about 3 μm.

In practice, various additives may be employed in the ink receiving layer and overcoat. These additives include surface active agents such as surfactant(s) to improve coatability and to adjust the surface tension of the dried coating, acid or base to control the pH, antistatic agents, suspending agents, antioxidants, hardening agents to cross-link the coating, antioxidants, UV stabilizers, light stabilizers, and the like. In addition, a mordant may be added in small quantities (2%-10% by weight of the base layer) to improve waterfastness. Useful mordants are disclosed in U.S. Pat. No. 5,474,843.

The layers described above, including the ink receiving layer and the overcoat layer, may be coated by conventional coating means onto a transparent or opaque support material commonly used in this art. Coating methods may include, but are not limited to, blade coating, wound wire rod coating, slot coating, slide hopper coating, gravure, curtain coating, and the like. Some of these methods allow for simultaneous coatings of both layers, which is preferred from a manufacturing economic perspective.

The DRL (dye receiving layer) is coated over the tie layer or TL at a thickness ranging from 0.1-10 μm, preferably 0.5-5 μm. There are many known formulations which may be useful as dye receiving layers. The primary requirement is that the DRL is compatible with the inks which it will be imaged so as to yield the desirable color gamut and density. As the ink drops pass through the DRL, the dyes are retained or mordanted in the DRL, while the ink solvents pass freely through the DRL and are rapidly absorbed by the TL. Additionally, the DRL formulation is preferably coated from water, exhibits adequate adhesion to the TL, and allows for easy control of the surface gloss.

For example, Misuda et al in U.S. Pat. Nos. 4,879,166; 5,264,275; 5,104,730; 4,879,166, and Japanese Patents 1,095,091; 2,276,671; 2,276,670; 4,267,180; 5,024,335; and 5,016,517 disclose aqueous based DRL formulations comprising mixtures of psuedo-bohemite and certain water soluble resins. Light in U.S. Pat. Nos. 4,903,040; 4,930,041; 5,084,338; 5,126,194; 5,126,195; and 5,147,717 disclose aqueous-based DRL formulations comprising mixtures of vinyl pyrrolidone polymers and certain water-dispersible and/or water-soluble polyesters, along with other polymers and addenda. Butters et al in U.S. Pat. Nos. 4,857,386 and 5,102,717 disclose ink-absorbent resin layers comprising mixtures of vinyl pyrrolidone polymers and acrylic or methacrylic polymers. Sato et al in U.S. Pat. No. 5,194,317 and Higuma et al in U.S. Pat. No. 5,059,983 disclose aqueous-coatable DRL formulations based on poly(viiiyl alcohol). Iqbal in U.S. Pat. No. 5,208,092 discloses water-based IRL formulations comprising vinyl copolymers which are subsequently cross-linked. In addition to these examples, there may be other known or contemplated DRL formulations which are consistent with the aforementioned primary and secondary requirements of the DRL, all of which fall under the spirit and scope of the current invention.

The preferred DRL is 0.1-10 micrometers thick and is coated as an aqueous dispersion of 5 parts alumoxane and 5 parts poly(vinyl pyrrolidone). The DRL may also contain varying levels and sizes of matting agents for the purpose of controlling gloss, friction, and/or fingerprint resistance, surfactants to enhance surface uniformity and to adjust the surface tension of the dried coating, mordanting agents, antioxidants, UV absorbing compounds, light stabilizers, and the like.

Although the ink-receiving elements as described above can be successfully used to achieve the objectives of the present invention, it may be desirable to overcoat the DRL for the purpose of enhancing the durability of the imaged element. Such overcoats may be applied to the DRL either before or after the element is imaged. For example, the DRL can be overcoated with an ink-permeable layer through which inks freely pass. Layers of this type are described in U.S. Pat. Nos. 4,686,118; 5,027,131; and 5,102,717. Alternatively, an overcoat may be added after the element is imaged. Any of the known laminating films and equipment may be used for this purpose. The inks used in the aforementioned imaging process are well known, and the ink formulations are often closely tied to the specific processes, i.e., continuous, piezoelectric, or thermal. Therefore, depending on the specific ink process, the inks may contain widely differing amounts and combinations of solvents, colorants, preservatives, surfactants, humectants, and the like. Inks preferred for use in combination with the image recording elements of the present invention are water-based, such as those currently sold for use in the Hewlett-Packard Desk Writer 560C printer. However, it is intended that alternative embodiments of the image-recording elements as described above, which may be formulated for use with inks which are specific to a given ink-recording process or to a given commercial vendor, fall within the scope of the present invention.

In another preferred embodiment of the invention, the invention comprises an imaging element comprising the label stock having a light sensitive and heat developable image forming unit or a light sensitive and pressure developable image forming unit provided thereon. In a preferred embodiment the element comprises an image forming unit which is light sensitive and pressure developable, i.e., it is exposed by light and developed by applying pressure. The image forming unit of the various element types may comprise one layer or more than one layer. At least one layer comprises a color-forming component that is preferably enclosed in a microcapsule and at least one layer comprises a color developer. The microcapsules and the developer particles may be in the same layer or in different layers. Preferably they are in the same layer. Preferably the microcapsules are light sensitive. More preferably the microcapsules are both light and pressure sensitive.

The light sensitive microcapsules useful for the practice of the invention comprise a color-forming component, a polymerizable compound, and a photopolymerization initiator. In the light sensitive and pressure developable imaging element, exposure to light according to a desired image causes the polymerizable compound present inside the microcapsules to harden the microcapsule interior by a polymerization reaction due to the radical generated from the photopolymerization initiator upon exposure so that a latent image in a desired shape is formed. That is, in the exposed portions, the color-forming reaction with the developer particles present outside the microcapsules is inhibited. Next, when pressure is applied to the imaging element, the microcapsules which have not hardened (the unexposed microcapsules) are broken which cause the color-forming component to move within the unexposed area to react with the developer particles to develop a color. Accordingly, the light sensitive and pressure developable image-imaging element is a positive-type, light sensitive and pressure developable imaging element in which the image formation is performed such that color formation is not made in exposed portions but color formation is made in the unexposed portions that do not harden.

Visible images can be made by heat development if the imaging element of the present invention is a light sensitive and heat-developable imaging element or by pressure development if the imaging element of the present invention is a light sensitive and pressure developable imaging material. The heat or pressure development can be carried out either simultaneously with the exposure for latent image formation or after the exposure.

A conventionally known heating method can be employed for the heat development. Generally, the heating temperature is preferably 80 to 200° C., more preferably 83 to 160° C., and most preferably 85 to 130° C. The duration of heating is preferably in the range of 3 seconds to 1 minute, more preferably in the range of 4 to 45 seconds, and most preferably in the range of 5 to 30 seconds.

The pressure development can be accomplished with a pressure applicator device. For example, the imaging material is developed by passing an exposed imaging media between a pair of calendar rollers that rupture the microcapsules, thereby allowing contact between the color-forming component and a developer that react to develop the image. The imaging material can also be developed by moving a point contact which is resiliently biased into engagement with the imaging sheet. Typically, the imaging sheet is secured to a cylinder and the point contact is positioned in resilient pressure contact with the imaging sheet. As the cylinder is rotated, the point contact is simultaneously moved along the cylinder in synchronism with the rotation of the cylinder to rupture the microcapsules and develop the image in the imaging sheet, or the imaging sheet may be mounted on a planer platform and the point contact is moved across the surface of the sheet using a screw thread in an X-Y transport device. The pressure that is to be applied is preferably 10 to 300 kg/cm², more preferably 80 to 250 kg/cm² , and most preferably 130 to 200 kg/cm². If the pressure is less than 10 kg/cm², sufficient density of developed color may not be obtained whereas, if the pressure exceeds 300 kg/cm², the discrimination of the images may not be sufficient because even the hardened microcapsules are broken. The compliant carrier sheet of the invention has been shown to provide uniform pressure to the microcapsules and provide excellent image formation.

The following examples illustrate the practice of this invention. They are not intended to be exhaustive of all possible variations of the invention. Parts and percentages are by weight unless otherwise indicated.

### EXAMPLES

### Example 1

In this example a thermal dye transfer pressure sensitive packaging label was created by applying a thermal dye transfer layers to a white pigmented polyolefin pragmatic sheet. The pragmatic sheet was pressure adhesive sensitive laminated to several voided polyester compliant carrier sheets. This example will demonstrate the improvement in printing efficiency and quality as the compliant factor of the compliant carrier sheet is increased.

Biaxially Oriented Polyolefin Pragmatic Sheet:

A composite sheet polyolefin sheet (75 μm thick) (d=0.93 g/cc) consisting of a oriented polypropylene core (approximately 60% of the total sheet thickness), with a homopolymer non-microvoided oriented polypropylene layer on each side of the core layer. The polyolefin sheet had a skin layer consisting of polyethylene. The polypropylene layer adjacent the core layer contained 6% anatase form of TiO₂. The thermal imaging layers were applied to the blue tinted polyethylene skin layer.

Pressure Sensitive Adhesive:

Permanent solvent based acrylic adhesive 25 micrometers thick containing 0.62% residual solvent.

Polyester Compliant Carrier Sheet:

The production of a compliant oriented polyester polymer base was a blend of particles of a linear polyester (PET) with between 0 and 25% by volume of particles of a homopolymer polyolefin (polypropylene), extruding the blend as a polymer film, quenching and biaxially orienting the film by stretching it in mutually perpendicular directions, and heat setting the vacuous polymer base. PET(#7352 from Eastman Chemicals) was dry blended with Polypropylene(“PP”, Huntsman P4G2Z-073AX.) Cast sheets were extruded using a 2-½ “extruder to extrude the PET/PP blend. The 275C meltstream was fed into a 7 inch film extrusion die also heated at 275 C. As the extruded sheet emerged from the die, it was cast onto a quenching roll set at 55C. The PP in the PET matrix dispersed into globules between 10 and 30 μm's in size during extrusion. The final dimensions of the continuous cast sheet were 18 cm wide and 1250 um's thick. The cast sheet was then stretched at 110 C first 3.2 times in the X-direction and then 3.4 times in the Y-direction. The stretched sheet was then Heat Set at 150 C.

During stretching voids were initiated around the particles of PP that were dispersed in the cast sheet. These voids grew during stretching and resulted in significant void volume. The resulting density of the stretched compliant polymer base was from 1.40 gm/cc to 0.6 gm/cc and the thickness was micrometer.

Structure of the label element of the example is as follows:

Polypropylene pragmatic sheet
Acrylic pressure sensitive adhesive
Silicone release coating
Compliant voided PET/Polyolefin carrier sheet

A Typical polycarbonate dye image-receiving layer was applied to the surface of the polyethylene skin layer at a coverage of 2.7 g/m². The imaging element was printed utilizing a Kodak 8670 PS Thermal Dye Transfer Printer. Several test images that contained graphics, text, and images were printed on the invention materials. At this point, the thermal dye transfer images were formed on the composite support. To further improve the durability of the developed image layers, an environmental protection layer was applied to the thermal dye transfer images.

The environmental protection layer was prepared using 7.5 μm ground polymer particles (styrene butyl acrylate available from Hercules as Piccotoner 1221), a soft latex binder (copolymer of butyl acrylate, 2-acrylamido-2-methylpropanesulfonate, and acetoacetoxyethylmethacrylate) as a 20% suspension, a hydrophilic thickening agent (Keltrol T) as a 1% solution, and a surfactant (Olin 10G) as a 10% solution. The melt was hand-coated using a 3 mil coating knife to form a 547 mg/ft² gelatin pad hardened with bisvinylsulfonyl-methylether at 2.43%. After spreading, the coatings were dried at 30° C.

The above thermal dye transfer label stocks utilizing the compliant carrier sheet were printed on a Kodak 8670 PS Thermal Dye Transfer Printer. Density test targets were printed so that density maximum could be measured with Status A reflection densitometer. Red, green and blue density maximum values for each composite carrier sheet is listed in Table 1 below.

TABLE 1

| Density of | | | |
|---|---|---|---|
| composite carrier | Red Density | Green Density | Blue Density |
| sheet (gm/cc) | Maximum | Maximum | Maximum |
| 1.40 | 1.61 | 1.60 | 1.63 |
| 1.18 | 1.69 | 1.70 | 1.68 |
| 0.97 | 1.92 | 1.95 | 1.92 |
| 0.64 | 2.17 | 2.20 | 2.16 |

As the data in Table 1 indicates, by decreasing the density of the compliant carrier sheet of the invention, the density maximum of the thermal dye transfer printed test target was significantly increased. Prior art thermal imaging receiving materials typically comprise voided polymer sheets located adjacent to the dye receiving layers. Surprisingly, the carrier sheet of the invention, while being voided, was located several layers below the dye receiving layer. In fact the compliant carrier sheet of the invention was located 100 micrometers below the dye receiver layer utilized in the example. By reducing the need for a voided pragmatic sheet, a greater number of adhesive and pragmatic sheet combination can be utilized to meet the needs of consumer goods labeling. In fact, with one compliant carrier sheet, many pragmatic sheet can be utilized significantly reducing the need, cost and complexity to void each pragmatic sheet. Further, pragmatic sheets that are difficult to void, such as cellulose paper, cellulose tri-acetate and polyurethane, can be efficiently printed by dye transfer printing process when used in combination with a compliant carrier sheet.

A density maximum value of between 2.0 and 2.2 are common to prior art materials containing voided polymers layers adjacent to the dye receiving layers. By providing levels of voiding in the carrier sheet, the label elements of the invention are equal in image quality to the prior art materials. The carrier sheet density of 1.4 in combination with a non-voided pragmatic sheet are consistent with prior art thermal printing materials that do not containing voiding, mainly transparent materials comprising 175 micrometers sheets of clear polyester containing a dye receiver layer.

As the data in Table 1 indicated, the preferred maximum density values are obtained by reducing the density of the compliant carrier sheet. As the density of the carrier sheet is reduced to increase thermal printing density, the pragmatic sheet becomes difficult to die cut utilizing known pressure dies because some of the die cutting energy is absorbed by the compliant carrier sheet. Non-contact methods for cutting the pragmatic sheets are preferred. Most preferred are reciprocal knife cutters or laser cutters. Both of these cutting methods have been shown to produce acceptable cut quality and allow for efficient dispensing of the label. Both the knife method and laser method of cutting do not require a rigid non-compliant surface that is required for the typical die cutting of labels. Additionally, die cutting of labels of a compliant carrier has been shown to provide poor cut quality resulting in inefficient label application.

The imaging element of the invention showed many significant improvements compared to prior art flexography or gravure printed labels. The invention provides a printing method that is economically viable when printing short runs, as the high cost of printing plates or printing cylinders are avoided. Because a thermal dye transfer system was used to print the labels, sequential label can be different without the need for expensive printing press setup costs. The use of thermal dye transfer images applied to a package ensures the highest image quality currently available compared to the common, but, lower quality six-color rotogravure printed images. Applying the environmental protection layer to the thermal dye transfer imaging layers significantly improves the image toughness and allows the thermal dye transfer image to be used in demanding labeling applications such as shampoo bottles or wine bottles.

Thermal dye transfer image technology utilized in the example can simultaneously print text, graphics, and photographic quality images on the same label. Since the thermal dye transfer imaging layers of the invention are digitally compatible, text, graphics, and images can be printed using known digital printing equipment such as lasers and CRT printers. Further, printing digital files allows the image files to be transported using electronic data transfer technology such as the internet, thus reducing the amount of time required for a packaging label change. Typically, a packaging label change utilizing the traditional methods of printing plates and cylinders required 10 weeks from concept to finished labels. The invention allows changes to occur in less than 1 hour.

While this example was directed at thermal dye transfer printed images on the composite base, ink jet printing, electro-photographic printing, pressure activated encapsulated dye bead printing and silver halide printing of the labels would yield an acceptable result. Finally, while this example was directed at labeling applications, the label element of the invention has utility for consumer printing of images, commercial mounting of images on back boards, bus wrap materials, album pages and the like.

The invention has been described in detail with particular reference to certain preferred embodiments thereof, but it will be understood that variations and modifications can be effected within the spirit and scope of the invention.

1. A label stock comprising in order at least one pragmatic sheet, a pressure sensitive adhesive and a compliant carrier sheet.

2. The label stock of claim 1 wherein said compliant carrier sheet will recover to 90% of original thickness after compression of between 25 and 50% of original thickness.

3. The label stock of claim 1 wherein said compliant carrier sheet recovers 95% of the original thickness in less than 2 seconds after removal of load.

4. The label stock of claim 1 wherein said compliant carrier sheet comprises at least one voided layer.

5. The label stock of claim 1 wherein said compliant carrier sheet comprises a polyester polymer sheet having at least one voided layer.

6. The label stock of claim 1 wherein said compliant carrier sheet comprises a voided layer adjacent said adhesive.

7. The label stock of claim 6 wherein said compliant carrier sheet comprises a release layer between said adhesive and said voided layer.

8. The label stock of claim 1 wherein said compliant carrier sheet has a compliant factor of between 20 and 100 micrometers measured at 1.2 MPa.

9. The label stock of claim 1 wherein said compliant carrier sheet has a modulus of at least 2500 MPa.

10. The label stock of claim 1 wherein said compliant carrier sheet is reflective to collimated light energy.

11. The label stock of claim 1 wherein said compliant carrier sheet has a surface resistivity of less than 1012 ohms per square.

12. The label stock of claim 1 wherein said adhesive has a thickness of between 12 and 25 micrometers.

13. The label stock of claim 1 wherein said at least one pragmatic sheet comprises a thermal dye receiver layer.

14. The label stock of claim 1 wherein said at least one pragmatic sheet has a bulk modulus of between 2000 and 100,000 MPa.

15. The label stock of claim 1 wherein said at least one pragmatic sheet comprises cellulose paper.

16. The label stock of claim 1 wherein said at least one pragmatic sheet is substantially transparent.

17. The label stock of claim 1 wherein said at least one pragmatic sheet comprises a gelatin layer adjacent to said adhesive.

18. The label stock of claim 1 wherein said compliant sheet is provided with a thermal dye receiving layer on the side opposite to said adhesive.

19. The label stock of claim 1 wherein said compliant sheet is provided with an ink jet receiving layer on the side opposite to said adhesive

20. A method of forming labels comprising providing a label stock comprising in order at least one pragmatic sheet, a pressure sensitive adhesive and a compliant carrier sheet, thermal dye transfer printing a label image on said pragmatic sheet, cutting said label image, and removing matrix material from said label images.

21. The method of claim 20 wherein cutting said label is performed with a laser cutter.

22. The method of claim 20 wherein cutting said label is performed with a reciprocating X-Y cutter.

23. The method of claim 20 wherein cutting said image does not cut said compliant sheet.

24. The method of claim 20 wherein cutting said image cuts to a depth of less than 5 micrometers.
